(19) United States
(12) Patent Application Publication
(10) Pub. No.: US 2014/0117967 A1
(43) Pub. Date: May 1, 2014

(54) REFERENCE VOLTAGE GENERATION CIRCUIT

(71) Applicant: Sony Corporation, Tokyo (JP)

(72) Inventors: Syou Mitsuishi, Fukuoka (JP); Toshio Suzuki, Fukuoka (JP); Hiroyasu Tagami, Fukuoka (JP); Nobuhiko Shigyo, Fukuoka (JP)

(73) Assignee: Sony Corporation, Tokyo (JP)

(21) Appl. No.: 14/032,269

(22) Filed: Sep. 20, 2013

(30) Foreign Application Priority Data
Oct. 26, 2012 (JP) 2012-236578

(51) Int. Cl. H02M 3/158

(52) U.S. Cl. CPC H02M 3/158
USPC 323/313

(57) ABSTRACT

Provided is a reference voltage generation circuit including a first circuit including a variable resistor and a PN junction device connected in series. The variable resistor and the PN junction device connected in series have a first current, that has temperature characteristics corresponding to a nonlinear component of temperature characteristics of an inter-terminal voltage of the PN junction device, caused to flow therethrough.

### CROSS REFERENCE TO RELATED APPLICATIONS

This application claims the benefit of Japanese Priority Patent Application JP 2012-236578 filed Oct. 26, 2012, the entire contents of which are incorporated herein by reference.

### BACKGROUND

The present disclosure relates to a reference voltage generation circuit that generates a constant reference voltage without depending on a power-supply potential.

From the past, there is known a bandgap reference circuit (hereinafter, referred to as BGR circuit) as a circuit that generates a constant reference voltage without depending on a power-supply potential.

In the BGR circuit, an adjustment is performed so as to suppress a voltage fluctuation due to a temperature as much as possible by an adjustment called trimming, and the BGR circuit is used in a state where primary temperature characteristics are canceled. However, cancel of secondary temperature characteristics (and secondary or more nonlinear temperature characteristics) of a base-emitter voltage V_{be} is difficult, and thus the secondary temperature characteristics seem like a large error depending on an application. In this regard, several methods of canceling secondary temperature characteristics are being proposed (see Japanese Patent Application Laid-open No. Hei 11-219233 (hereinafter, referred to as Patent Document 1) and “Curvature-Compensated BiCMOS Bandgap with 1-V Supply Voltage” by Piero Malcovati and Franco Maloberti, IEEEE JOURNAL OF SOLID-STATE CIRCUITS, VOL. 36, No. 7, JULY 2001 (hereinafter, referred to as Non-patent Document 1)).

### SUMMARY

However, there is a demerit that the BGR circuit disclosed in Patent Document 1 requires a complicated circuit. Further, the BGR circuit disclosed in Non-patent Document 1 has a demerit that while cancel of secondary temperature characteristics is being realized, there is a need to shake and check a temperature in trimming primary temperature characteristics, thus leading to an increase in costs.

In view of the circumstances as described above, there is a need to provide a reference voltage generation circuit for generating a reference voltage that does not depend on a power-supply potential and that enables secondary temperature characteristics to be canceled with a simple circuit structure and, more desirably, trimming of primary temperature characteristics to be carried out with ease at room temperature.

According to an embodiment of the present disclosure, there is provided a reference voltage generation circuit including a first circuit including a variable resistor and a PN junction device connected in series. The variable resistor and the PN junction device connected in series have a first current, that has temperature characteristics corresponding to a nonlinear component of temperature characteristics of an inter-terminal voltage of the PN junction device, caused to flow therethrough.

In the reference voltage generation circuit, the first current having the same temperature characteristics as the nonlinear component of the temperature characteristics of the inter-terminal voltage of the PN junction device flows through the first circuit. Since the first current flows through the first circuit, negative and positive voltages that are due to secondary or more temperature characteristics of the PN junction device are generated in the variable resistor of the first circuit. Therefore, in the first circuit, a voltage with a suppressed voltage fluctuation due to secondary or more temperature characteristics of the inter-terminal voltage of the PN junction device of the first circuit is generated. In other words, it becomes possible to generate a voltage with canceled secondary temperature characteristics with a simple circuit structure.

It should be noted that the embodiment of the present disclosure is not limited to the reference voltage generation circuit and includes various embodiments like embodying the reference voltage generation circuit in a state where the reference voltage generation circuit is incorporated into another apparatus (semiconductor device, electronic apparatus, etc.) or embodying the reference voltage generation circuit with other methods.

According to the embodiment of the present disclosure, it is possible to provide a reference voltage generation circuit capable of canceling secondary temperature characteristics with a simple circuit structure and easily performing trimming of primary temperature characteristics at room temperature.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a structural example of a reference voltage generation circuit according to an embodiment of the present disclosure;

FIG. 2 is a diagram for explaining temperature characteristics of a current flowing through a resistor R1;

FIG. 3 is a diagram for explaining temperature characteristics of a current flowing through a resistor R3;

FIG. 4 is a diagram for explaining temperature characteristics of a current flowing through a fourth node;

FIG. 5 is a diagram for explaining trimming of a reference voltage V_{bgr} according to the embodiment;

FIG. 6 is a diagram showing a structural example of a reference voltage generation circuit according to Modified Example 1; and

FIG. 7 is a diagram showing a structural example of a reference voltage generation circuit according to Modified Example 2.

### DETAILED DESCRIPTION OF EMBODIMENTS

Hereinafter, an embodiment of the present disclosure will be described in the following order.

(1) Structure of reference voltage generation circuit:

### (2) Modified Example 1:

### (3) Modified Example 2:

### (4) Summary:

### (1) Structure of Reference Voltage Generation Circuit

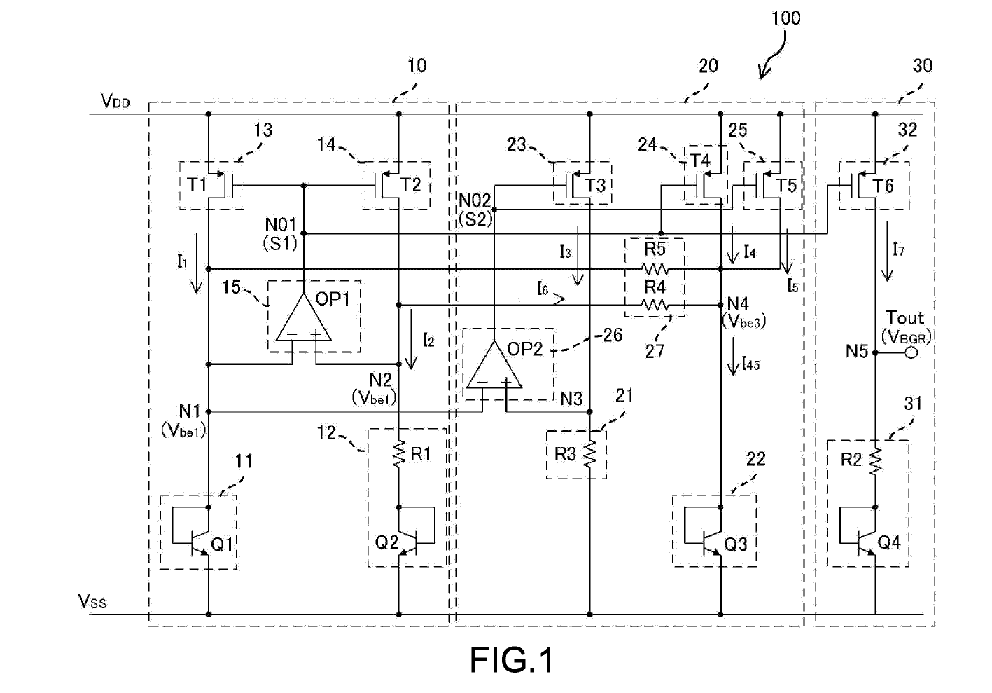

FIG. 1 is a circuit diagram showing a structure of a reference voltage generation circuit of this embodiment. The reference voltage generation circuit 100 is supplied with a first power-supply potential V_{DD} and a second power-supply potential V_{SS} (V_{SS}<V_{DD}) as a predetermined power-supply potential and generates a reference voltage (V_{BGR}−V_{SS}). Since it is general to set the second power-supply potential V_{SS} as a Ground Potential (0 V), descriptions below will be given on an example where V_{SS}=0.

The reference voltage generation circuit 100 includes a reference current control signal generation circuit 10 as a second circuit that generates a reference current control signal S1 and outputs it to a first control node N01, a correction circuit 20 as a third circuit that corrects nonlinear temperature characteristics of the reference current control signal S1 generated by the reference current control signal generation circuit 10, and a reference voltage output circuit 30 as a first circuit that outputs a reference voltage V_{BGR} to an output terminal Tₒᵤₜ by causing a current to flow based on the reference current control signal S1 in the first control node N01.

The first control node N01 is connected to a first current source 13, a second current source 14, a fourth current source 24, and a sixth current source 32 to be described later, and currents that flow through the first current source 13, the second current source 14, the fourth current source 24, and the sixth current source 32 are controlled by a voltage of the first control node N01.

(Reference Current Control Signal Generation Circuit)

The reference current control signal generation circuit 10 includes a first load circuit 11 connected between a first node N1 and the second power-supply potential V_{SS}, a second load circuit 12 connected between a second node N2 and the second power-supply potential V_{SS}, the first current source 13 that is connected between the first power-supply potential V_{DD} and the first node N1 and generates a current I₁ that flows through the first load circuit 11 based on the reference current control signal S1, the second current source 14 that is connected between the first power-supply potential V_{DD} and the second node N2 and generates a current I₂ that flows through the second load circuit 12 based on the reference current control signal S1, and a differential amplifier 15 as a first control circuit that amplifies a potential difference between the first node N1 and the second node N2 and generates the reference current control signal S1.

In FIG. 1, the first load circuit 11 is constituted of an NPN-type bipolar transistor Q1 (basically, NPN-type bipolar transistor will simply be referred to as transistor hereinafter) as a first PN junction device. The second load circuit 12 is constituted of a resistor R1 as a first resistor and a transistor Q2 as a second PN junction device that are connected in series in the stated order from the second node N2 side. The first current source 13 is constituted of a P-channel MOS transistor (hereinafter, referred to as pFET) T1. The second current source 14 is constituted of pFET T2, and the differential amplifier 15 is constituted of an operational amplifier OP1.

It should be noted that the transistors Q1 and Q2 are diode-connected by short-circuiting a base and an emitter and have different current densities.

In the reference current control signal generation circuit 10 structured as described above, the pFET T1 constituting the first current source 13 and the pFET T2 constituting the second current source 14 constitute a first current mirror circuit in which gates are mutually connected. By setting transistor sizes (channel lengths and channel widths) of the pFET T1 and pFET T2 to be the same, equivalent drain currents are generated in the pFET T1 and pFET T2.

The drain current of the pFET T1 is supplied to a collector and base of the transistor Q1. The emitter of the transistor Q1 is connected to the second power-supply potential V_{SS}. Accordingly, a voltage V_{be1} corresponding to a base-emitter voltage of the transistor Q1 is generated at both ends of the transistor Q1. In other words, the voltage of the first node N1 becomes the voltage V_{be1}.

On the other hand, the drain current of the pFET T2 is supplied to a collector and base of the transistor Q2 via the resistor R1. The emitter of the transistor Q2 is connected to the second power-supply potential V_{SS}. Accordingly, a voltage V_{be2} corresponding to a base-emitter voltage of the transistor Q2 is generated at both ends of the transistor Q2.

Here, the operational amplifier OP1 compares the first node N1 and the second node N2 and outputs, to the first control node N01, the reference current control signal S1 generated by amplifying a difference between the first node N1 and the second node N2. Gates of the pFET T1 and pFET T2 (and pFET T4 and pFET T6 to be described later) are connected to the first control node N01. Therefore, a state where the voltage of the second node N2 and the voltage of the first node N1 match is maintained. Since the voltage of the first node N1 is V_{be1} in FIG. 1, the voltage of the second node N2 is also maintained at V_{be1}.

At this time, both end voltages of the resistor R1 constituting the second load circuit 12 become ΔV_{be} shown in Expression (1) below, and the current I₂ shown in Expression (2) below flows through the resistor R1.

(Expression 1)

ΔV_{be}=V_{be1}−V_{be2} (1)

(Expression 2)

I₂=ΔV_{be}/R₁ (2)

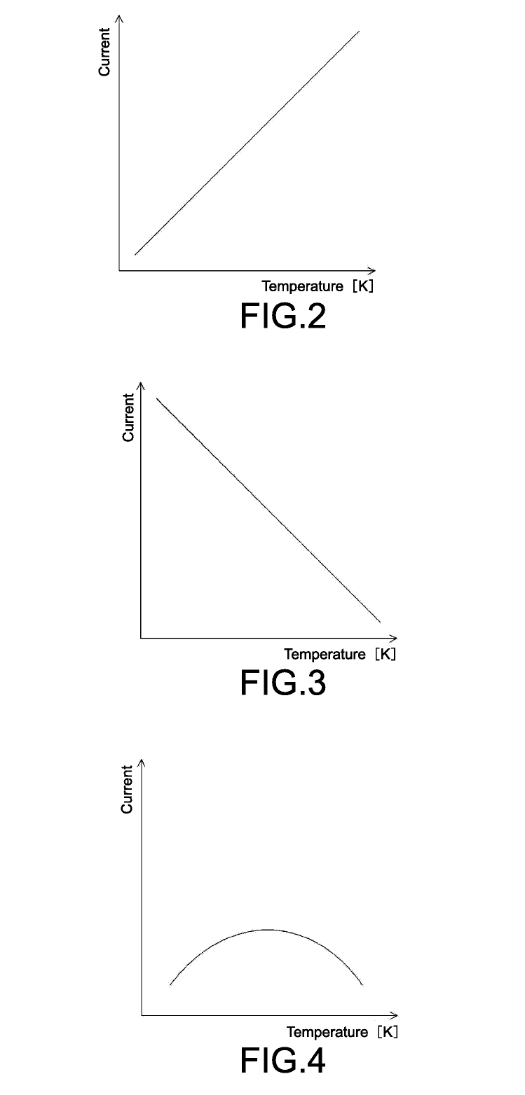

FIG. 2 is a diagram for explaining temperature characteristics of a current flowing through the resistor R1. ΔV_{be} as a difference between voltages of the transistors Q1 and Q2 having different current densities has primary linear temperature characteristics since the temperature characteristics of the voltages of the two transistors Q1 and Q2 are almost canceled. Therefore, as shown in FIG. 2, the current I₂ flowing through the resistor R1 to which ΔV_{be} is applied also has primary linear temperature characteristics.

(Correction Circuit)

Next, the correction circuit 20 includes a third load circuit 21, a fourth load circuit 22, a third current source 23, the fourth current source 24, a fifth current source 25, a differential amplifier 26 as a second control circuit, and a differential voltage equivalent current generation circuit 27.

The third load circuit 21 is connected between a third node N3 and the second power-supply potential V_{SS}.

The fourth load circuit 22 is connected between a fourth node N4 and the second power-supply potential V_{SS}.

The third current source 23 is connected between the third node N3 and the first power-supply potential V_{DD} and causes a current I₃ to flow through the third load circuit 21 based on a correction current control signal S2.

The fourth current source 24 is connected between the fourth node N4 and the first power-supply potential V_{DD} and causes a current I₄ to flow through the fourth load circuit 22 based on the reference current control signal S1.

The fifth current source 25 is connected between the fourth node N4 and the first power-supply potential V_{DD} and causes a current I₅ to flow through the fourth load circuit 22 based on the correction current control signal S2.

The differential amplifier 26 generates the correction current control signal S2 by amplifying a potential difference between the first node N1 and the third node N3 and outputs the correction current control signal S2 to a second control node N02 of the third current source 23 and the fifth current source 25.

The differential voltage equivalent current generation circuit 27 generates a current I₆ corresponding to a differential voltage between the second node N2 and the fourth node N4.

In FIG. 1, the third load circuit 21 is constituted of a resistor R3 as a second resistor. The fourth load circuit 22 is constituted of a transistor Q3 as a third PN junction device. The third current source 23 is constituted of a pFET T3. The fourth current source 24 is constituted of a pFET T4. The fifth current source 25 is constituted of a pFET T5. The differential amplifier 26 is constituted of an operational amplifier OP2. The differential voltage equivalent current generation circuit 27 is constituted of a resistor R4 as a third resistor that connects the second node N2 and the fourth node N4 and a resistor R5 that connects the first node N1 and the fourth node N4.

In the correction circuit 20 structured as described above, the fourth current mirror circuit is structured by connecting a gate of the pFET T4 constituting the fourth current source 24 to the first control node N01 like the pFET T1 and pFET T2 described above. By setting the transistor size (channel length and channel width) of the pFET T4 to be the same as that of the pFET T1 and pFET T2, a drain current equivalent to that of the pFET T1 and pFET T2 flows through the pFET T4.

Further, the pFET T3 constituting the third current source 23 and the pFET T5 constituting the fifth current source 25 are connected to thus structure the third current mirror circuit with mutually-connected gates. By setting the transistor sizes (channel lengths and channel widths) of the pFET T3 and pFET T5 to be the same, equivalent drain currents are generated in the pFET T3 and pFET T5.

Here, the operational amplifier OP2 compares voltages of the first node N1 and the third node N3 and outputs, to the second control node N02, the correction current control signal S2 generated by amplifying a difference between the voltages of the first node N1 and the third node N3. The gates of the pFET T3 and the pFET T5 are connected to the second control node N02. Accordingly, a state where the voltages of the first node N1 and the third node N3 match is maintained.

At this time, since the voltage of the first node N1 is V_{be1} in FIG. 1, the voltage of the third node N3 also becomes V_{be1}, and the current I₃ of Expression (3) below flows through the resistor R3.

(Expression 3)

I₃=V_{be1}/R₃ (3)

FIG. 3 is a diagram for explaining temperature characteristics of a current that flows through the resistor R3. As shown in the figure, the current I₃ that flows through the resistor R3 by a base-emitter voltage V_{be1} generated by the current flowing through the transistor Q1 shows the same temperature characteristics as the base-emitter voltage V_{be1} of the transistor Q1. Specifically, the current I₃ has a negative temperature coefficient in which secondary or more nonlinear component is not canceled as shown in FIG. 3.

Further, the current I₃ generated as described above is transferred to the drain current of the pFET T5 by the third current mirror circuit formed between the pFET T3 and pFET T5. Moreover, the current I₂ flowing through the pFET T2 is transferred to the drain current of the pFET T4 by the fourth current mirror circuit formed between the pFET T2 and pFET T4.

Therefore, a current I₄₅ obtained by adding the current I₃ (current I₅) and the current I₂ (current I₄) is generated in the fourth node N4. Since the current I₃ has the same temperature characteristics as the base-emitter voltage V_{be1} of the transistor Q1 as described above and the current I₂ has the same primary linear temperature characteristics as described above, the current I₄₅ shows flat temperature characteristics in which primary temperature characteristics are canceled as shown in FIG. 4.

The current I₄₅ is supplied to the collector and base of the transistor Q3. The emitter of the transistor Q3 is connected to the second power-supply potential V_{SS}. Accordingly, a voltage V_{be3} corresponding to the base-emitter voltage of the transistor Q3 is generated at both ends of the transistor Q3, and the voltage of the fourth node N4 becomes the voltage V_{be3}. At this time, a potential difference corresponding to a difference between the voltage V_{be1} and the voltage V_{be3} is generated between the second node N2 and the fourth node N4.

Here, characteristics of the voltage V_{be1} and the voltage V_{be3} will be described logically. First, Expression (4) below is a general expression of a base-emitter voltage of a general bipolar transistor.

(Expression 4)

V_{be}(T)=V_{BG}−(V_{BG}−V_{BE0})T/Tᵣ−(η−α)kT/q*ln(T/Tᵣ) (4)

In Expression (4), V_{BG} represents a PN junction bandgap voltage (e.g., 1 V in case of silicon), V_{BE0} represents the base-emitter voltage V_{be} at a time an absolute temperature is 0 (K), Tᵣ represents a reference temperature (e.g., room temperature) in observing a temperature fluctuation of the base-emitter voltage V_{be} itself, η represents a value determined by a semiconductor process (material, doping amount, concentration, etc.) (generally “4”), and α represents a value that varies depending on a level of current caused to flow through the bipolar transistor (“1” in state where current having positive temperature characteristics is caused to flow through bipolar transistor and “0” in state where PTAT (a term proportional to absolute temperature) current is caused to flow through bipolar transistor).

It can be seen from Expression (4) that, by taking a difference between V_{be} (PTAT) at a time the PTAT current is flowing in the case of α=1 and V_{be} (Flat) at a time a current with flat temperature characteristics is flowing in the case of α=0, only a nonlinear component indicated by the final term of Expression (4) can be taken out as shown in Expression (5) below.

$$\begin{matrix}( Expression 5 ) & \\ \begin{matrix}{V}_{diff} = {V}_{be} ( PTAT ) - {V}_{be} ( Flat ) \\ = kT / q * ln ( T / {T}_{t} )\end{matrix} & ( 5 )\end{matrix}$$

Here, V_{be2} described above corresponds to V_{be} (PTAT) in Expression (5) above, and V_{be3} described above corresponds to V_{be} (Flat) in Expression (5) above. Therefore, a voltage having only the nonlinear component corresponding to V_{diff} in Expression (5) above is generated between the second node N2 and the fourth node N4.

Therefore, by causing the current flowing between the second node N2 and the fourth node N4 via the resistor R4 (hereinafter, referred to as correction current) to flow through the pFET T2 via the second node N2, the current I₂ shown in Expression (6) below, that is obtained by adding the PTAT current and the correction current, flows through the pFET T2. It should be noted that the resistor R5 adjacent to the resistor R4 in FIG. 1 is provided for biasing the first node N1.

(Expression 6)

I₂=ΔV_{be}/R1+V_{T}/R4*ln(T/Tᵣ) (6)

(Reference Voltage Output Circuit)

Next, the reference voltage output circuit 30 is structured by including a fifth load circuit 31 connected between a fifth node N5 and the second power-supply potential V_{SS} and a sixth current source 32 that is connected between the fifth node N5 and the first power-supply potential V_{DD} and causes a current I₇ to flow through the fifth load circuit 31. It should be noted that an output terminal Tₒᵤₜ for the reference voltage generation circuit 100 to output the reference voltage V_{BGR} is connected to the fifth node N5.

In the reference voltage output circuit 30 structured as described above, the fifth load circuit 31 is constituted of the variable resistor R2 and the transistor Q4 connected in series. The variable resistor R2 corresponds to the variable resistor of the first circuit, and the transistor Q4 corresponds to the PN junction device of the first circuit. The pFET T6 constituting the sixth current source 32 constitutes the second current mirror circuit in which a gate thereof is connected to the first control node N01 like the pFET T1 and pFET T2 described above. By setting the transistor size (channel length and channel width) of the pFET T6 to be the same as that of the pFET T1 and pFET T2, the drain current of the pFET T6 becomes the current I₇ equivalent to the current I₂ of Expression (6) above that flows through the pFET T2.

By causing the current I₇ to flow in the reference voltage output circuit 30, a reference voltage V_{bgr} shown in Expression (7) below is generated in the fifth load circuit 31.

(Expression 7)

V_{bgr}=V_{be4}+(ΔV_{be}/R1+V_{T}/R4*ln(T/Tᵣ))R₂ (7)

In Expression 7 above, V_{be4} represents a base-emitter voltage generated in the transistor Q4.

Since the reference voltage V_{bgr} generated as described above is uniquely determined by appropriately adjusting the value of the variable resistor R2, primary temperature characteristics can be canceled by adjusting the voltage to a desired voltage only at room temperature.

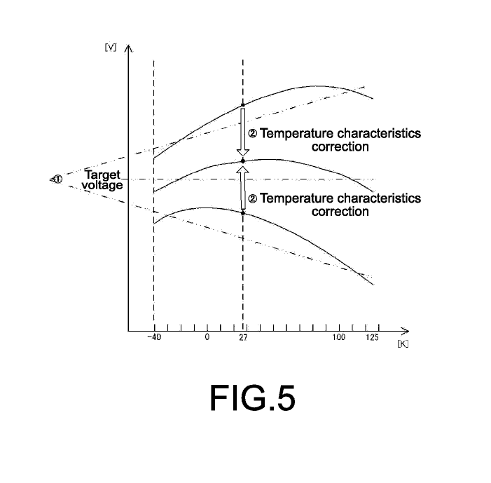

FIG. 5 is a diagram for explaining trimming of the reference voltage V_{bgr} of this embodiment. As shown in the figure, as in a case of a normal BGR voltage output circuit (circuit that does not correct secondary temperature characteristics) of the related art, by directly creating an output of the reference voltage V_{bgr} of this embodiment by adding the voltage generated in the variable resistor by the PTAT current and the base-emitter voltage V_{be4} generated in the transistor Q4 at the final stage, trimming for canceling primary temperature characteristics becomes possible by merely monitoring an output voltage at room temperature without causing a deviation in the absolute value.

As a result, it is possible to suppress, while canceling the secondary temperature characteristics (including secondary or more nonlinear component), a trimming cost as compared to the technique disclosed in Non-patent Document 1 described in the background art. Moreover, canceling of the secondary temperature characteristics (including secondary or more nonlinear component) can be realized with a simpler circuit structure than in the technique disclosed in Patent Document 1 described in the background art.

### (2) Modified Example 1

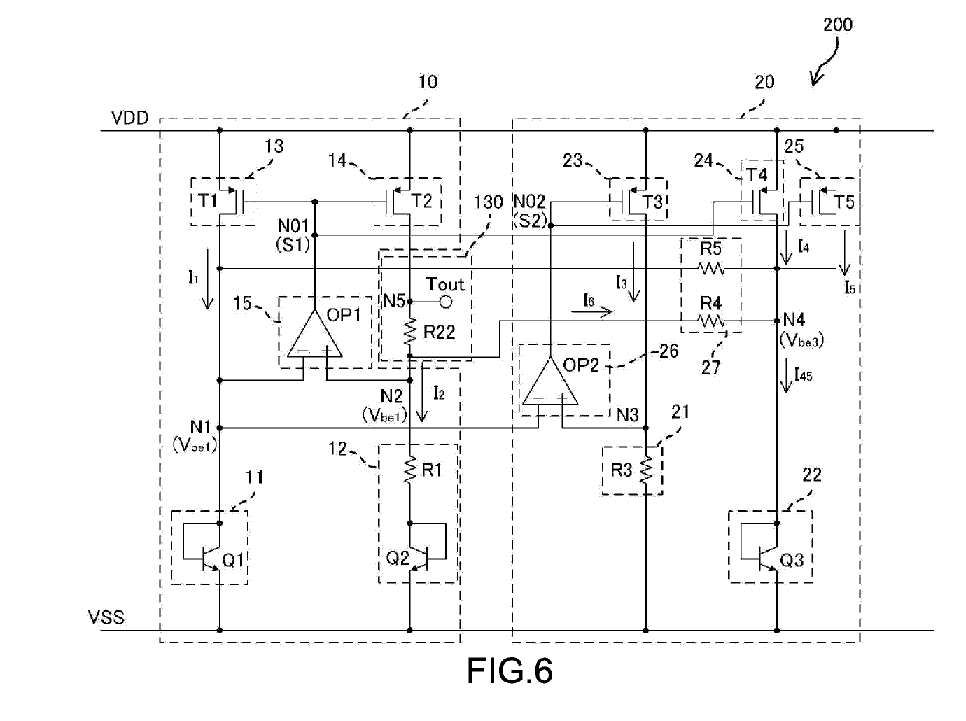

It should be noted that the structure of Modified Example 1 shown in FIG. 6 may be adopted. FIG. 6 is a circuit diagram showing a structure of a reference voltage generation circuit 200 according to Modified Example 1. In Modified Example 1, a portion that outputs a reference voltage is changed to a portion on a line on which the first current source 13 and the second load circuit 12 are arranged. It should be noted that in the descriptions on FIG. 6 and Modified Example 1, structures that are the same as those of the reference voltage generation circuit 100 according to the embodiment above are denoted by the same symbols, and detailed descriptions thereof will be omitted.

As shown in FIG. 6, in the reference voltage generation circuit 200, the reference voltage output circuit 30 of the reference voltage generation circuit 100 is replaced with a variable resistor R22 having the same function as the variable resistor R2 of the reference voltage generation circuit 100, the variable resistor R22 being provided between the second node N2 and the second current source 14. The output terminal Tₒᵤₜ for outputting the reference voltage V_{bgr} is connected between the variable resistor R22 and the second current source 14.

With this structure, a current obtained by adding the PTAT current described above and the current I₆ generated by the correction circuit flows through the variable resistor R22. Since the same voltage V_{be1} as in the embodiment above is generated in the second node N2, a voltage obtained by adding the voltages generated at both ends of the variable resistor R22 and the voltage V_{be1} of the second node N2 is output from the output terminal Tₒᵤₜ as the reference voltage V_{bgr}.

According to the reference voltage generation circuit 200 of Modified Example 1, since the pFET T6 and the transistor Q4 can be omitted, the circuit area can be reduced.

### (3) Modified Example 2

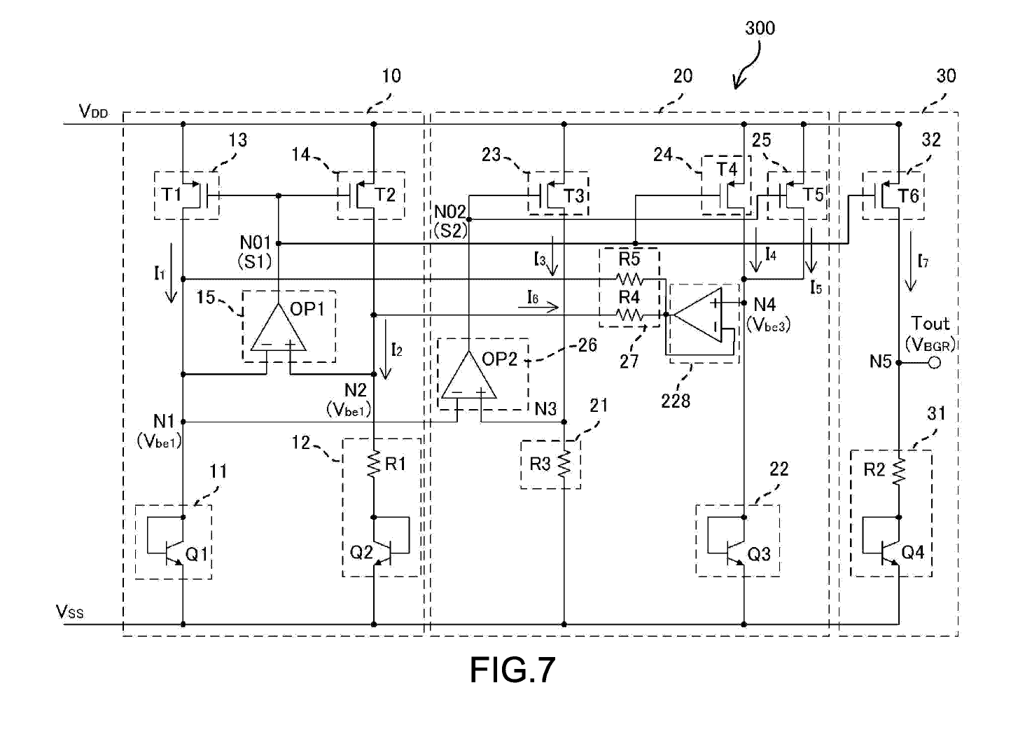

Further, for shutting out an influence of a deviation from an ideal value due to the current I₆, a buffer may be inserted as in Modified Example 2 shown in FIG. 7. FIG. 7 is a circuit diagram showing a structure of a reference voltage generation circuit 300 according to Modified Example 2. It should be noted that in the descriptions on FIG. 7 and Modified Example 2, structures that are the same as those of the reference voltage generation circuit 100 according to the embodiment above are denoted by the same symbols, and detailed descriptions thereof will be omitted.

As shown in FIG. 7, in the reference voltage generation circuit 300, a buffer 228 is added between the resistors R4 and R5 and the fourth node N4. Although there logically is a need to cause a current that does not have a temperature dependency to flow through the transistor Q3 constituting the fourth load circuit 22 connected to the fourth node N4, the current flowing through the transistor Q3 is deviated from an ideal correction current when the current I₆ is inserted and removed. Therefore, by enabling the differential voltage equivalent current generation circuit 27 to be buffered, an influence of the correction current on the transistor Q3 can be reduced, and thus an additional improvement in accuracy can be expected.

### (4) Summary

The reference voltage generation circuit according to the embodiment described heretofore is a reference voltage generation circuit that includes the reference voltage output circuit 30 including the variable resistor and the PN junction device connected in series and causes the current I₇, that has the temperature characteristics corresponding to the nonlinear component of the temperature characteristics of the inter-terminal voltage of the PN junction device, to flow through the variable resistor R2 and the transistor Q4 of the reference voltage output circuit 30. By causing the current I₇ to flow through the reference voltage output circuit 30 in the reference voltage generation circuit structured as described above, a positive or negative voltage opposite from the voltage due to the secondary or more temperature characteristics of the PN junction device is generated in the variable resistor R2 of the reference voltage output circuit 30. Therefore, a voltage with a suppressed voltage fluctuation due to the secondary or more temperature characteristics of the inter-terminal voltage of the transistor Q4 of the reference voltage output circuit 30 is generated in the reference voltage output circuit 30. In other words, it becomes possible to generate a voltage with canceled secondary temperature characteristics with a simple circuit structure.

It should be understood by those skilled in the art that various modifications, combinations, sub-combinations and alterations may occur depending on design requirements and other factors insofar as they are within the scope of the appended claims or the equivalents thereof.

The present disclosure may also take the following structures.

(A) A reference voltage generation circuit, including

a first circuit including a variable resistor and a PN junction device connected in series,
the variable resistor and the PN junction device connected in series having a first current, that has temperature characteristics corresponding to a nonlinear component of temperature characteristics of an inter-terminal voltage of the PN junction device, caused to flow therethrough.
   (B) The reference voltage generation circuit according to (A) above, further including:

a second circuit configured to generate a second current having the same temperature characteristics as a differential voltage between inter-terminal voltages of two PN junction devices having different current densities; and

a third circuit configured to generate a third current having temperature characteristics corresponding to a nonlinear component of temperature characteristics of the inter-terminal voltages of the PN junction devices,
the first current being a current obtained by adding the second current and the third current.
   (C) The reference voltage generation circuit according to (B) above,

in which the second circuit includes
a first load circuit that is connected between a first node and a predetermined power-supply potential by a first PN junction device as one of the two PN junction devices having different current densities,
a second load circuit that is connected between a second node and the predetermined power-supply potential by a series connection of a second PN junction device as the other one of the two PN junction devices having different current densities and a first resistor,
a first current mirror circuit that transfers a current flowing through the first node to the second node so that the current flows through the second load circuit, and
a first control circuit that causes a potential of the first node to match a potential of the second node, and

in which the second current is a current that flows through the first resistor.

(D) The reference voltage generation circuit according to (A) or (B) above,

in which the first current is transferred to the first circuit by a second current mirror circuit and flows through the variable resistor and the PN junction device connected in series.

(E) The reference voltage generation circuit according to (C) above,

in which the variable resistor of the first circuit has a current, that is transferred from the first node to the second node by the first current mirror circuit, flowing therethrough by being connected to the second node, and

in which the PN junction device of the first circuit and the second PN junction device are shared.

(F) The reference voltage generation circuit according to (B) or (C) above,

in which the third circuit includes
a third load circuit constituted of a second resistor that is connected between a third node and the predetermined power-supply potential,
a fourth load circuit constituted of a third PN junction device that is connected between a fourth node and the predetermined power-supply potential,
a second control circuit that causes a potential of a third resistor that connects the fourth node and the second node and potentials of the third node and the first node to match,
a third current mirror circuit that transfers a current flowing through the third node to the fourth node so that the current flows through the fourth load circuit, and
a fourth current mirror circuit that transfers a current flowing through the second node to the fourth node so that the current flows through the fourth load circuit, and
   in which the third current is a current that flows through the third resistor.
      (G) The reference voltage generation circuit according to (F) above,

in which the third resistor is connected to the fourth node via a buffer.

(H) A semiconductor device, including

the reference voltage generation circuit according to any one of (A) to (G) above.

(I) An electronic apparatus, including

the reference voltage generation circuit according to any one of (A) to (G) above.

What is claimed is:

1. A reference voltage generation circuit, comprising
a first circuit including a variable resistor and a PN junction device connected in series,
the variable resistor and the PN junction device connected in series having a first current, that has temperature characteristics corresponding to a nonlinear component of temperature characteristics of an inter-terminal voltage of the PN junction device, caused to flow therethrough.

2. The reference voltage generation circuit according to claim 1, further comprising:
a second circuit configured to generate a second current having the same temperature characteristics as a differential voltage between inter-terminal voltages of two PN junction devices having different current densities; and
a third circuit configured to generate a third current having temperature characteristics corresponding to a nonlinear component of temperature characteristics of the inter-terminal voltages of the PN junction devices,
the first current being a current obtained by adding the second current and the third current.

3. The reference voltage generation circuit according to claim 2,
wherein the second circuit includes
a first load circuit that is connected between a first node and a predetermined power-supply potential by a first PN junction device as one of the two PN junction devices having different current densities,
a second load circuit that is connected between a second node and the predetermined power-supply potential by a series connection of a second PN junction device as the other one of the two PN junction devices having different current densities and a first resistor,
a first current mirror circuit that transfers a current flowing through the first node to the second node so that the current flows through the second load circuit, and
a first control circuit that causes a potential of the first node to match a potential of the second node, and
wherein the second current is a current that flows through the first resistor.

4. The reference voltage generation circuit according to claim 1,
wherein the first current is transferred to the first circuit by a second current mirror circuit and flows through the variable resistor and the PN junction device connected in series.

5. The reference voltage generation circuit according to claim 3,
wherein the variable resistor of the first circuit has a current, that is transferred from the first node to the second node by the first current mirror circuit, flowing therethrough by being connected to the second node, and
wherein the PN junction device of the first circuit and the second PN junction device are shared.

6. The reference voltage generation circuit according to claim 3,
wherein the third circuit includes
a third load circuit constituted of a second resistor that is connected between a third node and the predetermined power-supply potential,
a fourth load circuit constituted of a third PN junction device that is connected between a fourth node and the predetermined power-supply potential,
a second control circuit that causes a potential of a third resistor that connects the fourth node and the second node and potentials of the third node and the first node to match,
a third current mirror circuit that transfers a current flowing through the third node to the fourth node so that the current flows through the fourth load circuit, and
a fourth current mirror circuit that transfers a current flowing through the second node to the fourth node so that the current flows through the fourth load circuit, and
wherein the third current is a current that flows through the third resistor.

7. The reference voltage generation circuit according to claim 6,
wherein the third resistor is connected to the fourth node via a buffer.

8. A semiconductor device, comprising
the reference voltage generation circuit according to claim 1.

9. An electronic apparatus, comprising
the reference voltage generation circuit according to claim 1.
